(19) United States
(12) Patent Application Publication
(10) Pub. No.: US 2013/0276016 A1
(43) Pub. Date: Oct. 17, 2013

(54) SET TOP BOX AND SYSTEM PARAMETER SETTING METHOD

(71) Applicant: HON HAI PRECISION INDUSTRY CO., LTD., New Taipei (TW)

(72) Inventors: KUAN-FU HUANG, New Taipei (TW); I-CHIH CHEN, New Taipei (TW)

(73) Assignee: HON HAI PRECISION INDUSTRY CO., LTD., New Taipei (TW)

(21) Appl. No.: 13/776,720

(22) Filed: Feb. 26, 2013

(30) Foreign Application Priority Data
Apr. 17, 2012 (TW) 101113682

(51) Int. Cl. H04N 21/41

(52) U.S. Cl. CPC H04N 21/4126
USPC 725/25

(57) ABSTRACT

A set top box, communicating with a handheld device, authenticates the handheld device according to an authenticating signal received from the handheld device, and assigns a unique identifier to the handheld device that has been authenticated. The set top box further stores the unique identifier into a user favorite table, sets the set top box according to a setting signal received from the handheld device that has been authenticated, and stores a user favorite recorded in the setting signal and the unique identifier of the handheld device into the user favorite table.

### BACKGROUND

1. Technical Field

Embodiments of the present disclosure generally relate to a set top box, and more particularly to a system parameter setting method of a set top box according to a user favorite.

2. Description of Related Art

A set top box (STB) is a popular multimedia device to many families. The STB may present various channels, different volume and control methods to satisfy different favorites of users. However, the STB is incapable of recording a favorite of a particular user and automatically setting a system parameter of the STB according to the favorite of the particular user. As a result, a user has to manually set the system parameter of the STB according to his favorite before using the STB, which is time-consuming and unfriendly. Thus, the STB is not intelligent and unfriendly to users.

### BRIEF DESCRIPTION OF THE DRAWINGS

FIG. 1 is a schematic diagram of an application environment of one embodiment of a set top box (STB) in accordance with the present disclosure.

FIG. 2 is a block diagram of one embodiment of functional modules of the STB in FIG. 1.

FIG. 3 is an exemplary diagram of a user favorite table of one embodiment.

FIG. 4 is a flowchart of one embodiment of a system parameter setting method of the STB.

FIG. 5 is a flowchart of another embodiment of the system parameter setting method of the STB.

FIG. 6 is a flowchart of another embodiment of the system parameter setting method of the STB.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

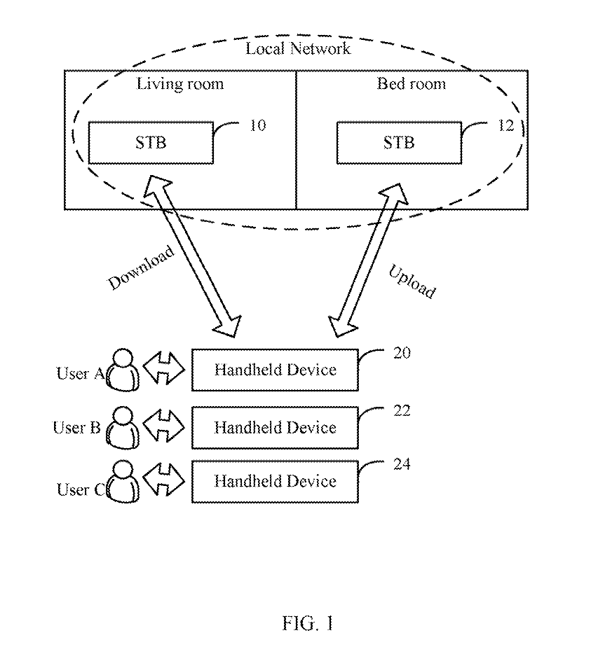

FIG. 1 is a schematic diagram of an application environment of one embodiment of a set top box (STB) 10 and a STB 12 in accordance with the present disclosure. As referred in FIG. 1, the STB 10 is in a living room and the STB 12 is in a bed room. A user A takes a handheld device 20, a user B takes a handheld device 22, and a user C takes a handheld device 24. In one embodiment, the handheld devices 20, 22, 24 may be a tablet computer, a mobile communication device, and a smart phone, for example. In one embodiment, the user A, B, or C set a system parameter of one of the STB 10 and the STB 12 by the handheld devices 22, 24, 26 for one time, and then the system parameters of the other STB 10 or 12 can be set automatically for the user A, the user B or the user C, which avoids duplicating setting the STB 10 or the STB 12 to satisfy a favorite of a particular user.

As the user A is equivalent to the user B or the user C, and the STB 10 is equivalent to the STB 12, the following introduces the present disclosure in detail by mainly taking the user A, the handheld device 20, and the STB 10 as an example.

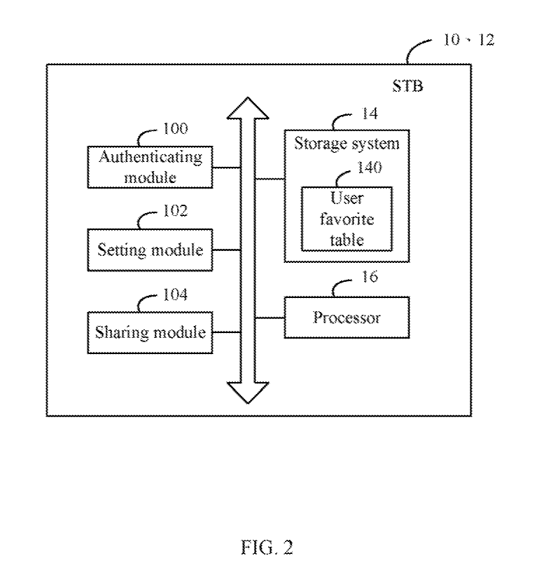

FIG. 2 is a block diagram of functional modules of the STB 10 in FIG. 1. The STB 10 includes an authenticating module 100, a setting module 102, a sharing module 104, a storage system 14, and at least one processor 16. In one embodiment, the modules 100-104 may comprise computerized code in the form of one or more programs that are stored in the storage system 14, and the storage system 14 stores a user favorite table 140. The computerized code includes instructions that are executed by the at least one processor 16 to provide functions for the modules 100-104. In one example, the storage system 14 may include a hard disk drive, a flash memory, a cache or another computerized memory device. The STB 10 can change a user favorite in the user favorite table 140 according to a user command

In one embodiment of the present disclosure, the handheld device 20 transmits an authenticating signal to the STB 10, and the authenticating module 100 authenticates the handheld device 20 according to the authenticating signal. Then, the authenticating module 100 assigns a unique identifier to the handheld device 20 and stores the unique identifier into the user favorite table 140. In one embodiment, the unique identifier may be a medium access control (MAC) address of the handheld device 20, or a subscriber identity module (SIM) number which can be used to identify the handheld device 20. The STB 10 authenticates a plurality of handheld devices by assigning different unique identifiers to the plurality of handheld devices.

When the handheld device 20 has been authenticated, the setting module 102 sets a system parameter of the STB 10 according to a user favorite recorded in a setting signal received from the handheld device 20. In one embodiment, the user favorite may include information about at least one of volume, favorite channels, login information for accessing the Internet, and control methods adopted between the STB 10 and the handheld device 20. Then, the setting module 102 stores the user favorite and the corresponding unique identifier of the handheld device 20 into the user favorite table 140.

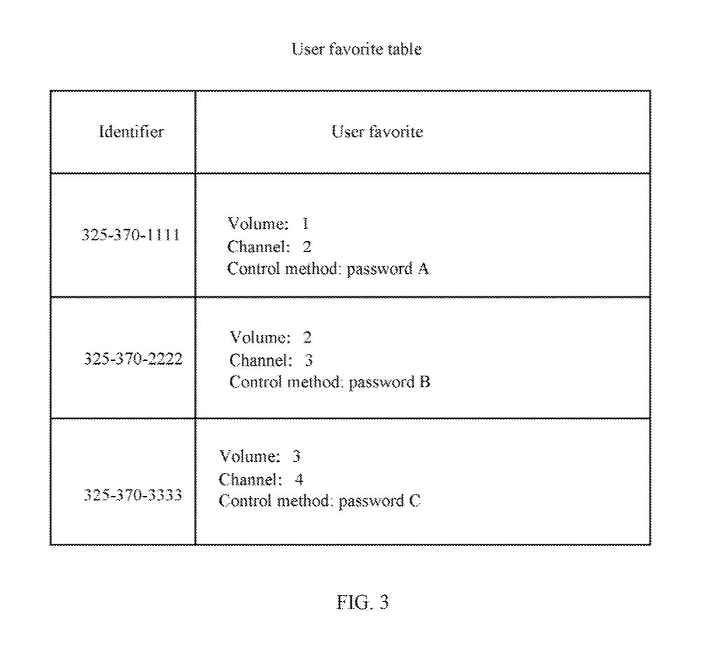

FIG. 3 is an exemplary diagram of the user favorite table 140. In one embodiment, the user favorite table 140 includes an identifier field storing unique identifiers of the plurality of handheld devices 20, 22, 24 and a user favorite field storing user favorites corresponding to the unique identifiers. In one embodiment, the handheld device 20 may be a smart phone, and the unique identifier is a SIM number of the smart phone. In one example, the SIM number of the handheld device 20 is 325-370-1111 corresponding to a first user favorite including volume 1, channel 2 and password A that can be used to access the STB 10. A SIM number of the handheld device 22 may be 325-370-2222 corresponding to a second user favorite including volume 2, channel 3 and password B. A SIM number of the handheld device 24 is 325-370-3333 corresponding to a third user favorite including volume 3, channel 4 and password C. All of the SIM numbers and corresponding user favorites mentioned above are stored in the user favorite table 140.

The following presents three examples related to applications of the STB 10.

In a first example, if a system parameter of the STB 10 has been set according to the second user favorite of the user B and the user A wants to use the STB 10, the handheld device 20 used by the user A may transmit a setting signal to the STB 10. The setting module 102 receives the setting signal and sets a system parameter of the STB 10 according to the first user favorite stored in the user favorite table 140 automatically, therefore, the user A is free from setting the STB 10 and gains a good experience.

In a second example, if the STB 10 has been set and the user A wants to use the current user favorite to set other STB, the handheld device 20 transmits an upload sharing signal to the STB 10, and the sharing module 104 of the STB 10 receives the upload sharing signal and downloads the current user favorite to the handheld device 20 according to a corresponding unique identifier of the handheld device 20.

In a third example, if the user A moves from the living room to the bed room and wants to use the STB 12 that has not been set according to a user favorite corresponding to the handheld device 20, the handheld device 20 transmits the user favorite to the STB 12. Then, the authenticating module 100 of the STB 12 authenticates the handheld device 20, and the sharing module 104 of the STB 12 receives the user favorite from the handheld device 20 and stores the user favorite, and the setting module 102 of the STB 12 sets a system parameter of the STB 12 according to the user favorite table 140 stored in the storage system 14. As mentioned above, the STB 12 is equivalent to the STB 10 and has the same functions as the STB 10. Therefore, if the user A moves from the bed room to the living room, the STB 10 can function as the STB 12 mentioned in the third example.

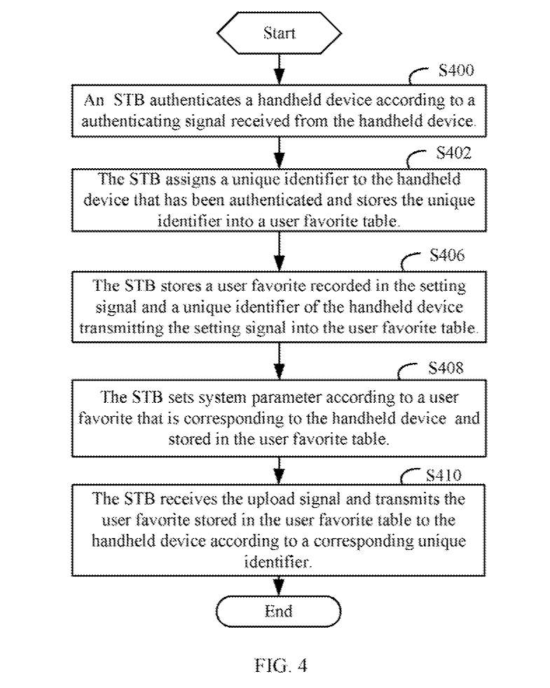

Referring to FIG. 4, it is a flowchart of one embodiment of a method for setting the STB 10. In one embodiment, the method functions in the application environment in FIG. 1 and by the modules in FIG. 2 in the manner following.

In block S400, the STB 10 authenticates the handheld device 20 according to an authenticating signal received from the handheld device 20.

In block S402, the STB 10 assigns a unique identifier to the handheld device 20 that has been authenticated and stores the unique identifier into the user favorite table 140 as referred in FIG. 3.

In block S404, the setting module 102 storing a user favorite recorded in the setting signal and a unique identifier of the handheld device 20 transmitting the setting signal into the user favorite table 140.

If a system parameter of the STB 10 has been set according to a user favorite of the user B, the handheld device 20 transmits a setting signal to the STB 10 to cause the STB 10 resetting according to a user favorite of the user A automatically. That is, in block S406, the setting module 102 sets a system parameter of the STB 10 according to a user favorite that is corresponding to the handheld device 10 and stored in the user favorite table 140.

When a system parameter of the STB 10 has been set and the user A wants to use the current user favorite on other STB, the handheld device 20 may transmit an upload signal to the STB 10. That is, in bock S 408, the sharing module 104 receives the upload signal and downloads the current user favorite stored in the user favorite table 140 to the handheld device 20 according to a corresponding unique identifier.

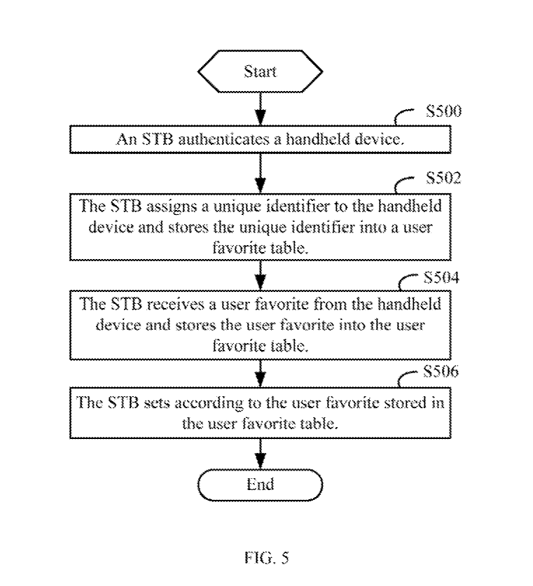

Referring to FIG. 5, this is a flowchart of another embodiment of the method for setting the STB 12, for example. In one embodiment, the method functions in the application environment in FIG. 1 and by the modules in FIG. 2 in the manner following.

If the user A moves from the living room to the bed room and wants to use the STB 12 that has not been set according to a user favorite corresponding to the handheld device 20, the handheld device 20 transmits the user favorite to the STB 12. In block S500, the authenticating module 100 authenticates the handheld device 20, and in block S502, the authenticating module 100 assigns a unique identifier to the handheld device 20 and stores the unique identifier into the user favorite table 140 as referred in FIG. 3. In block S504, the sharing module 104 receives a user favorite from the handheld device 20 and stores the user favorite into the user favorite table 140. In block S506, the setting module 102 sets the STB 12 according to the user favorite stored in the user favorite table 140.

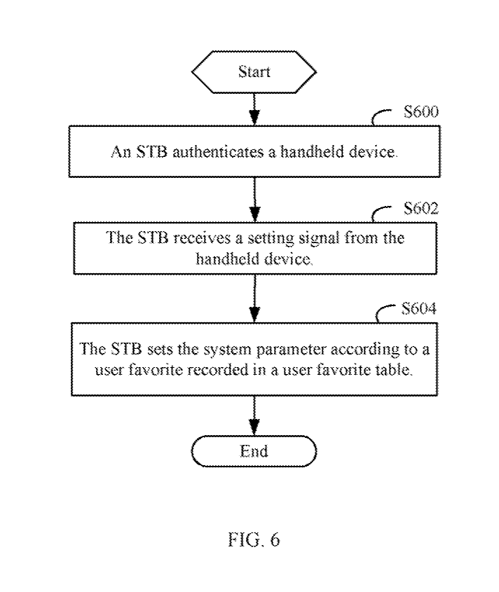

In one embodiment, if the storage system 14 has stored a user favorite table 140 that records a user favorite and a corresponding unique identifier of the handheld device 20, in block S600, referring to FIG. 6, the STB 10 authenticates the handheld device 20. In block S602, the setting module 102 receives a setting signal that does not record a user favorite from the handheld device 20. In block S604, the setting module 102 sets the system parameter of the STB 10 according to the user favorite recorded in the user favorite table 140 according to the unique identifier of the handheld device 20.

The method and the STB in the present disclosure greatly facilitate the STB to reset itself quickly and automatically according a user favorite.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A set top box, communicating with a handheld device, comprising:
at least one processor;
a storage system storing a user favorite table;
one or more programs that are stored in the storage system and are executed by the at least one processor, comprising:
an authenticating module, authenticating the handheld device according to an authenticating signal received from the handheld device, assigning a unique identifier to the handheld device that has been authenticated, and storing the unique identifier into the user favorite table; and
a setting module, setting a system parameter of the set top box according to a setting signal with a user favorite received from the handheld device that has been authenticated, and storing the user favorite recorded in the setting signal and the unique identifier of the handheld device into the user favorite table.

2. The set top box as claimed in claim 1, wherein the setting module acquires the user favorite corresponding to the unique identifier of the handheld device from the user favorite table and sets the system parameter of the set top box according to the acquired user favorite.

3. The set top box as claimed in claim 2, further comprising a sharing module transmitting the user favorite stored in the user favorite table to the handheld device according to the unique identifier.

4. The set top box as claimed in claim 3, wherein the sharing module further receives the user favorite from the handheld device and storing the user favorite into the user favorite table.

5. The set top box as claimed in claim 4, wherein the user favorite comprises at least one volume, at least one favorite channel, login information for accessing the Internet, and at least one control method between the handheld device and the set top box.

6. A method for setting a system parameter of a set top box, the set top box communicating with a handheld device, the method comprising:
providing a storage system storing a user favorite table;
authenticating the handheld device according to an authenticating signal received from the handheld device;
assigning a unique identifier to the handheld device that has been authenticated;
storing the unique identifier into the user favorite table;
setting the system parameter of the set top box according to a setting signal with a user favorite received from the handheld device that has been authenticated; and
storing the user favorite recorded in the setting signal and the unique identifier of the handheld device transmitting the setting signal into the user favorite table.

7. The method as claimed in claim 6, further comprising:
acquiring the user favorite corresponding to the unique identifier of the handheld device from the user favorite table and setting the system parameter of the set top box according to the acquired user favorite.

8. The method as claimed in claim 7, further comprising:
transmitting the user favorite stored in the user favorite table to the corresponding the handheld device according to the unique identifier.

9. The method as claimed in claim 8, further comprising:
receiving the user favorite from the handheld device and storing the user favorite into the user favorite table.

10. The method as claimed in claim 9, wherein the user favorite comprises at least one volume, at least one favorite channel, login information for accessing the Internet, and at least one control method adopted between the handheld device and the set top box.

11. A method for setting a system parameter of a set-top box communicating with a handheld device, the method comprising:
providing a user favorite table comprising a unique identifier of the handheld device and a user profile corresponding to the unique identifier of the handheld device;
receiving a setting signal from the handheld device;
acquiring the user favorite corresponding to the unique identifier of the handheld device from the user favorite table; and
setting the system parameter of the set-top box according to the acquired user favorite.

12. The method as claimed in claim 11, wherein the user favorite comprises at least one volume, at least one favorite channel, login information for accessing the Internet, and at least one control method adopted between the handheld device and the set top box.
